(19) United States
(12) Patent Application Publication
(10) Pub. No.: US 2017/0305630 A1
(43) Pub. Date: Oct. 26, 2017

(54) Method of Securing Food

(71) Applicant: Jeffrey L. Miller, Trumbull, CT (US)

(72) Inventor: Jeffrey L. Miller, Trumbull, CT (US)

(21) Appl. No.: 15/380,147

(22) Filed: Dec. 15, 2016

Related U.S. Application Data
(60) Provisional application No. 62/325,575, filed on Apr. 21, 2016.

(51) Int. Cl. B65D 79/00; B65D 5/66; B65C 3/08; B65D 25/20; B65B 7/28

(52) U.S. Cl. CPC B65D 79/00; B65D 25/205; B65B 7/2842; B65C 3/08; B65D 5/66

(57) ABSTRACT

A method of securing food in a delivery food container includes preparing food, placing the prepared food in the delivery food container, placing a tamper-evident seal across an opening of the delivery food container to secure the prepared food in the delivery food container, and delivering the sealed delivery food container. The tamper-evident seal may be a label, such as an adhesive label, and may display indicia when placed across the opening of the delivery food container. The indicia may include at least one of color, text, and a hologram. The delivery food container may include one of a box, a bag, and a wrapper.

### BACKGROUND

### 1. Field

The present application relates to a method of securing food stored in a container, and more particularly, securing food in a container with a tamper-evident seal.

### 2. State of the Art

Delivered prepared foods, such as prepared from pizzerias and other restaurants, may be delivered in containers (e.g., cardboard box or paper bag) that are not sealed, leaving open the possibility that the contents of the food may be tampered with before the prepared food is delivered to an unsuspecting consumer.

Tamper evident tapes and labels may be used for protecting items, containers and products such as envelopes, from opening without leaving evidence of tampering or opening. Some known tamper evident tapes and labels are scored tapes that can easily be removed from products such as envelopes through use of means such as adhesive tape. Also, some known tamper evident tapes can be tampered with unnoticeably in low or high temperature environments. Further, some known tamper evident tapes and labels are costly.

One known tamper evident tape or label uses hidden indicia (e.g., lettering) on one part of the tape, such that the indicia are revealed when the tape is tampered with. However, the tamper evident feature may be defeated (i.e., the tapes may not provide evidence of tampering) if the tape is removed or lifted in high or low temperature environments. For example, when such tape is heated to temperatures of about 80-90 degrees Celsius, a layer of the tape that attaches the tape to the container can become weaker, and, therefore, becomes easily removable and re-attachable without exposing the hidden indicia.

Another known method for tamper evident tapes and labels uses color changing heat sensitive means embodied within the tape. Such tapes change color when the tape is exposed to increased temperature, generally of around 80 degrees centigrade. However, such tapes are also known to change color when exposed to prolonged temperatures of about 60 degrees Celsius, thus possibly giving false indication of tampering.

Another known method for tamper evident tapes and labels uses a tape having at least one layer which includes continuous webs of fracture or cuts in a known and pre-designated manner. When such tape is removed, the tape will fracture so that the interconnecting portion between the tape and the container will indicate that the tape has been tampered with. When an additional layer of material is attached to the layer of continuous webs of fracture it is possible, under certain conditions, to remove and re-attach the tape without leaving evidence that the tape was tampered with. Thus, the tamper evident feature of such tapes may be circumvented by attaching another tape, which is adherable on one side of the aforementioned-layer and lifting the two tapes as a whole without creating any discernable fragments in the continuous webs of fracture.

### SUMMARY

In accordance with a first aspect, which will be discussed in further detail below, a method of securing food in a delivery food container is provided which includes preparing food, placing the prepared food in the delivery food container, placing a tamper-evident seal across an opening of the delivery food container to secure the prepared food in the delivery food container, and delivering the sealed delivery food container. The tamper-evident seal may be a label, such as an adhesive label, and may display indicia when placed across the opening of the delivery food container. The indicia may include at least one of color, text, and a hologram. The delivery food container may include one of a box, a bag, and a wrapper.

In accordance with a second aspect, which will be discussed in further detail below, a secured food container is provided which includes a closed delivery food container containing prepared food therein and a tamper-evident seal placed across an opening of the closed delivery food container to secure the prepared food in the delivery food container. The tamper-evident seal may display text when placed across the opening of the closed delivery food container. The delivery food container may include one of a box, a bag, and a wrapper. The tamper-evident seal may be a label bearing indicia, including at least one of color, text, and a hologram. The tamper-evident seal is configured to adhere to delivery food containers made from one or more of paper, cardboard, plastic, and metal foil. The tamper-evident seal may be configured to adhere to the delivery food containers when subjected to temperatures up to 500 degrees Fahrenheit. The tamper-evident seal protects the food delivery from the time it is applied at the food establishment, until the time it reaches the consumer, who is the only party intended to open the food delivery container after it is sealed.

### BRIEF DESCRIPTION OF THE DRAWINGS

FIG. 1 shows an embodiment of a tamper evident seal placed on a food container.

FIG. 1A shows an embodiment of a temper evident seal placed on a food container, where the seal bears advertising.

FIG. 2 illustrates an embodiment of a workflow of securing food.

### DETAILED DESCRIPTION

As used herein, the term “delivery food container” refers to containers used by any food establishment, such as a restaurant, that prepares food in its establishment and delivers the prepared food outside its establishment. Such containers are generally disposable and may be made from one or more of paper, cardboard, plastic, and metal foil. Without limitation, examples of delivery food containers include cardboard pizza boxes, paper boxes (typical for Chinese restaurants), paper and plastic bags, wax paper, and metal foil pouches. As used herein, the term “tamper-evident” refers to visual evidence of tampering. As used herein, the term “tamper-evident seal” refers to a visual indicator that the seal has been broken and that the seal has been opened.

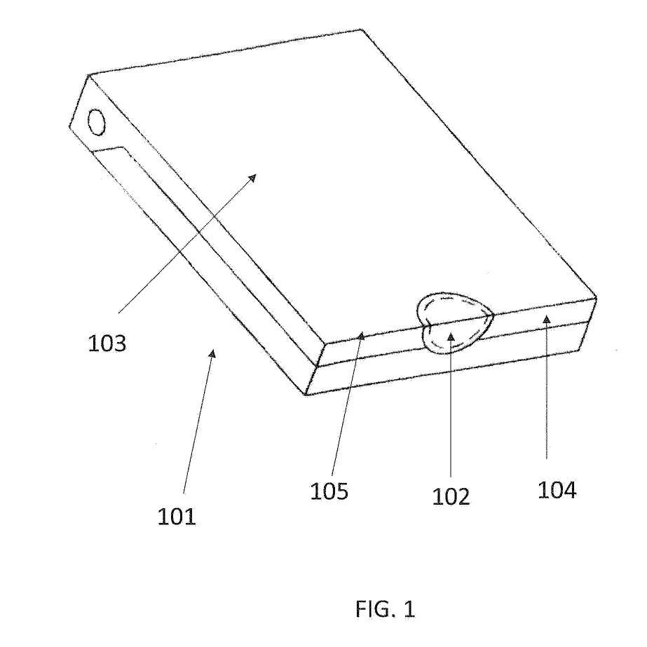

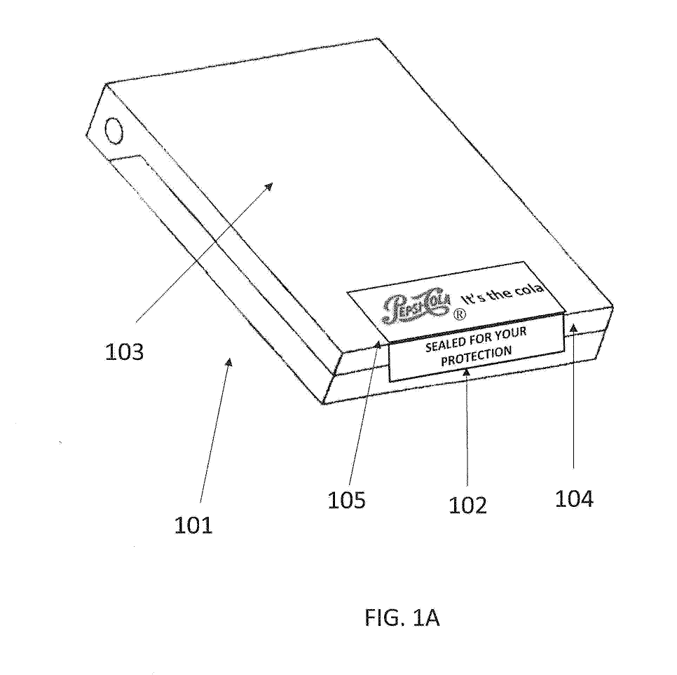

FIG. 1 shows a delivery food container 101 that is sealed with a tamper-evident seal 102. The seal 102 is applied to parts of the container 101 that closes access to the food contents (not shown) in the container 101. The container 101 in FIG. 1 is a box having a hinged lid 103 and a front side 104. The hinge may be a fold in the box material. The seal 102 is shown attached to the lid 103 and the front side 104 across an opening 105 of the container 101, which prevents the lid 103 from being opened, and thereby protecting the food contents from being tampered with. While only one seal 102 is shown in FIG. 1, it will be appreciated that additional seals may be used for added security.

The tamper-evident seal 102 may be formed as a small adhesive-backed label that is applied across the opening 105 of the container 103. The tamper-evident seal 102 may be manufactured as a roll of labels attached to an adhesive transfer medium, as is known, and peeled off of the roll and placed on the container 101 when securing prepared food in the container 101. The tamper-evident seal 102 may be made from Syntherm® (a registered trademark of Acucote, Inc. of Graham, N.C.) TE/SA200/40#, a product of Acucote, Inc. of Graham, N.C. The tamper-evident seal 102 may also be configured to adhere directly to delivery food containers made from one or more of paper, cardboard, plastic, and metal foil. Preferably, the tamper-evident seal 102 will remain adhered to the delivery food container 101 even when the seal 102 is subjected to temperatures up to 500 degrees Fahrenheit. This may prevent the tamper-evident seal 102 from falling off delivery food containers 101 that contain heated prepared foods. The tamper-evident seal 102 is attached securely to the delivery food container such that portions of the seal 102 remain attached to the delivery food container 101 when the seal 102 is tampered with and especially when the delivery food container 101 has been opened, thereby providing a visual indication of the state of the container 101 to a consumer receiving the container 101.

The tamper-evident seal 102 may be rectangular and have dimensions of about 1 inch×2 inches. Also, the tamper-evident seal 102 may have other dimensions and/or shapes, such as square, circular, or triangular. Preferably, the tamper-evident seal 102 is easily visible to a user such that it facilitates quick review of its condition upon receipt of the delivered food container 101. The tamper-evident seal 102 may be a label and bear indicia. Such indicia may include one or more of text, color(s) (e.g., red, blue and/or silver), and hologram(s). For example, the seal 102 may display text, such as “SEALED FOR YOUR PROTECTION”. Also, as shown in FIG. 1A, the seal 102 may display advertising, which may include one or more of a logo, a company name (e.g., PEPSICO®), a product name (e.g., PEPSI®), and a tagline (e.g., “It's the cola”). The tamper-evident seal 102 protects the food delivery from the time it is applied at the food establishment, until the time it reaches the consumer, who is the only party who is intended to open the food delivery container after it is sealed.

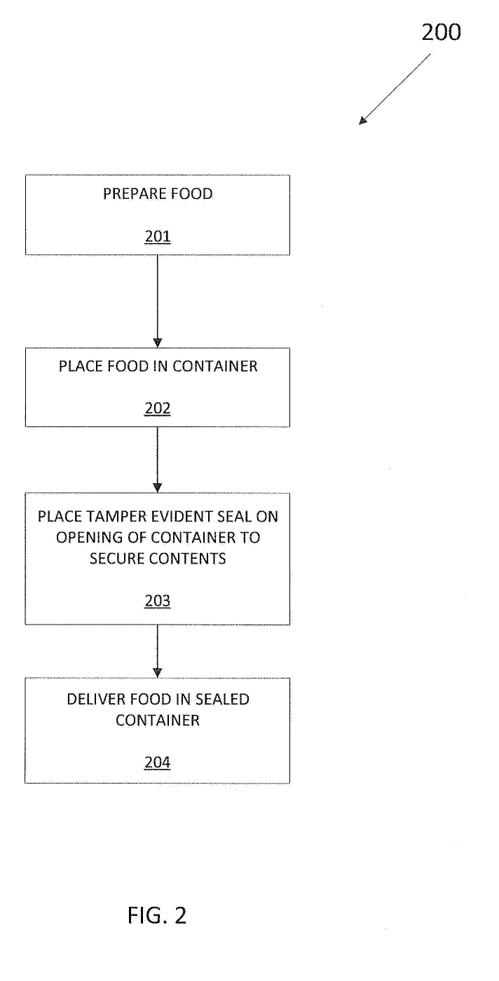

FIG. 2 illustrates an embodiment of a workflow 200 for securing food in a delivery food container 101. At 201 food is prepared in an establishment, such as by a food establishment that delivers prepared food for delivery outside of their establishment. At 202 the prepared food is placed in a delivery food container, such as container 101 in FIG. 1. At 203 a tamper-evident seal, such as seal 102 in FIG. 1, is placed across an opening, such as opening 105, of the delivery food container to secure the food contents inside the delivery food container. For example, where the tamper-evident seal is an adhesive label on a roll of labels, one of the labels may be peeled off the roll and applied to the delivery food container. At 204 the sealed delivery food container is delivered by an employee of the establishment or by a third party to a customer.

There have been described and illustrated herein several embodiments of a method of securing food in a delivery food container and a tamper-evident seal. While particular embodiments of the invention have been described, it is not intended that the invention be limited thereto, as it is intended that the invention be as broad in scope as the art will allow and that the specification be read likewise. Thus, while particular tamper-evident seals have been disclosed, it will be appreciated that similar seals may be used as well. In addition, while particular types of delivery food containers have been disclosed, it will be understood other types can be used. It will therefore be appreciated by those skilled in the art that yet other modifications could be made to the provided invention without deviating from its spirit and scope as claimed.

What is claimed is:

1. A method of securing food in a delivery food container, the method comprising:
placing prepared food in the delivery food container; and
placing a tamper-evident seal across an opening of the delivery food container to secure the prepared food in the delivery food container.

2. The method according to claim 1, further comprising:
preparing the food; and
delivering the sealed delivery food container.

3. The method according to claim 1, wherein the tamper-evident seal displays text when placed across the opening of the delivery food container.

4. The method according to claim 1, wherein delivery food container includes one of a box, a bag, and a wrapper.

5. The method according to claim 1, wherein the tamper-evident seal is a label bearing indicia.

6. The method according to claim 5, wherein the indicia include at least one of color, text, advertising, and a hologram.

7. The method according to claim 5, wherein the indicia include at least advertising and a statement that the container has been sealed.

8. A secured food container comprising:
a closed delivery food container containing prepared food therein; and
a tamper-evident seal placed across an opening of the closed delivery food container to secure the prepared food in the delivery food container.

9. The secured food container according to claim 8, wherein the tamper-evident seal displays text when placed across the opening of the closed delivery food container.

10. The secured food container according to claim 8, wherein the delivery food container includes one of a box and a bag.

11. The secured food container according to claim 8, wherein the tamper-evident seal is a label bearing indicia.

12. The secured food container according to claim 11, wherein the indicia include at least one of color, text, advertising, and a hologram.

13. The secured food container according to claim 8, wherein the tamper-evident seal is configured to adhere to delivery food containers made from one or more of paper, cardboard, plastic, and metal foil.

14. The secured food container according to claim 13, wherein the tamper-evident seal is configured to adhere to the delivery food containers when subjected to temperatures up to 500 degrees Fahrenheit.

15. The secured food container according to claim 11, wherein the indicia include at least advertising and a statement that the container has been sealed.
